(19) United States
(12) Patent Application Publication
(10) Pub. No.: US 2019/0041078 A1
(43) Pub. Date: Feb. 7, 2019

(54) METHOD AND SYSTEM FOR DETECTION OF HVAC ANOMALIES AT THE COMPONENT LEVEL

(71) Applicant: General Electric Company, Schenectady, NY (US)

(72) Inventors: Abhay HARPALE, San Ramon, CA (US); Jianbo YANG, San Ramon, CA (US); Abhishek SRIVASTAV, San Ramon, CA (US); James JOBIN, San Ramon, CA (US)

(21) Appl. No.: 16/048,906

(22) Filed: Jul. 30, 2018

Related U.S. Application Data
(60) Provisional application No. 62/542,027, filed on Aug. 7, 2017.

(51) Int. Cl. F24F 11/38; G06N 3/04; G06N 3/08; F24F 11/63

(52) U.S. Cl. CPC F24F 11/38; F24F 11/63; G06N 3/08; G06N 3/04

(57) ABSTRACT

A system and method including, for each component of a system, defining filter flags that identify measurements that correspond to a particular operating condition of the respective component, the identified measurements being sensor measurements relevant to build a predictive model of expected output for each component of the system; defining input sensors for each of the components; defining at least one output sensor for each of the components; filtering data from the system based on the defined filter flags for each respective component; building, based on the defined input sensors for each respective component, a predictive model for the defined output sensor; determining a divergence between actual data values and expected values predicted by the model for each respective component; determining a component-specific anomaly score for each component of the system; and storing a record of the component-specific anomaly score for each component of the system.

### BACKGROUND

Heating, ventilation and air conditioning (HVAC) systems are generally a big energy draw and energy efficiency is paramount to their operation and maintenance. As such, malfunctioning or inefficient HVAC units typically lead to significant costs, not only in terms of HVAC unit repairs, but also in terms of lost customers for a business, wasted product for perishable items, and uncomfortable working/living environments. In some contexts, detecting problems with HVAC units at a component or HVAC subsystem level may result in significant savings realized via timely intervention.

### BRIEF DESCRIPTION OF THE DRAWINGS

FIG. 1 is an example schematic diagram for an anomaly detection system;

FIG. 2 is an illustrative flow diagram of a process, according to some embodiments;

FIG. 3 is an illustrative example of an anomaly detection system and data types for a cooler model of a HVAC system;

FIGS. 4A-4D include illustrative example graphs of data for the cooler of FIG. 3;

FIG. 5 includes example data for a cooler of a HVAC system;

FIG. 6 includes additional example data for a cooler of a HVAC system;

FIG. 7 is an illustrative example of an anomaly detection system and data types for a heater model of a HVAC system;

FIGS. 8A-8D include illustrative example graphs of data for the heater of FIG. 7;

FIG. 9 is an illustrative example of an anomaly detection system and data types for a damper model of a HVAC system;

FIGS. 10A-10D include illustrative example graphs of data for the damper of FIG. 9; and

FIG. 11 is an example block diagram of a system, in some embodiments herein.

### DETAILED DESCRIPTION

The following description is provided to enable any person in the art to make and use the described embodiments. Various modifications, however, will remain readily apparent to those in the art.

In some aspects of the present disclosure, one embodiment includes a method for the detection of HVAC (heating, ventilation and air conditioning) anomalies and failures at a component level. However, the methods and systems herein might be applied to other systems comprising subsystems and components distinct from a HVAC system.

In the present disclosure, a HVAC system is divided into three components key to proper operation of the HVAC system. The key components should, individually and/or in combination, indicate a health of the system. In some embodiments, the HVAC system may be represented by more, fewer, and other components than the three discussed in the primary examples herein.

In the present example, the key components of the HVAC system include a cooler that provides the cooling of the HVAC system, a heater that provides the heating of the HVAC system, and a damper that regulates a mixture of inside air and outside air supplied to the HVAC system to facilitate an efficient operation of the HVAC system. Each of these subsystems can be defined and represented separately by methodologies and logic disclosed herein, where the underlying logic can be applied to each of the three subsystems, as well as other subsystems and components of the HVAC system or other systems.

In some embodiments, given certain particular input variables, the output of the HVAC system can be accurately predicted. The output of the HVAC system may be expressed in terms of the supply air temperature (SAT) (i.e., the air that immediately exits the HVAC unit). In some embodiments, given different particular input variables, under different operating conditions, the present disclosure includes methods and systems to predict the output of the HVAC system. In particular, we have measurements of the actual observed supply air temperature (SAT) and expected supply air temperature (SAT) values. Additionally, we can compare the actual and predicted SAT values to determine whether the system is operating as expected (i.e., healthy) or a divergence to get a health score.

In some embodiments herein, conditions for building a model of each subsystem of the HVAC (or other) system is defined. For each model herein, the following are defined: the inputs, the outputs, and the expected range of error, in terms of predictions, that can be tolerated.

As an example, filter flags are defined to define or specify a cooler model by defining filter flags that identify measurements that correspond to a particular operating condition. For the cooler system example, the filter flags may include the cooling output being greater than zero (i.e., cooling system is on); the primary heating output is equal to zero (i.e., primary heater is not on); a secondary heating output is equal to zero (i.e., the secondary heater is not on); and the fan status is greater than zero (i.e., the fan is blowing or on). If these conditions are met, then a cooler health estimator model may be built. Otherwise, a cooler estimator need not be built since a cooler is indicated as not being operated in the system.

Additionally, input sensors are defined. For a HVAC cooler, the supply of the cooling system might be defined to depend on the variables of: return air temperature, outside air temperature, fan status, cooling output, and economizer damper position. For the cooler example, the output sensor can be defined as the supply air temperature.

In some embodiments herein, the three types of information (i.e., filter flags, inputs sensors, and output sensors) may be used to build a model for the components or subsystems of the HVAC (or other) system. In some embodiments, models may be built using physical equations or in a data-driven manner that is robust and accommodating of variations in, for example, installations sites.

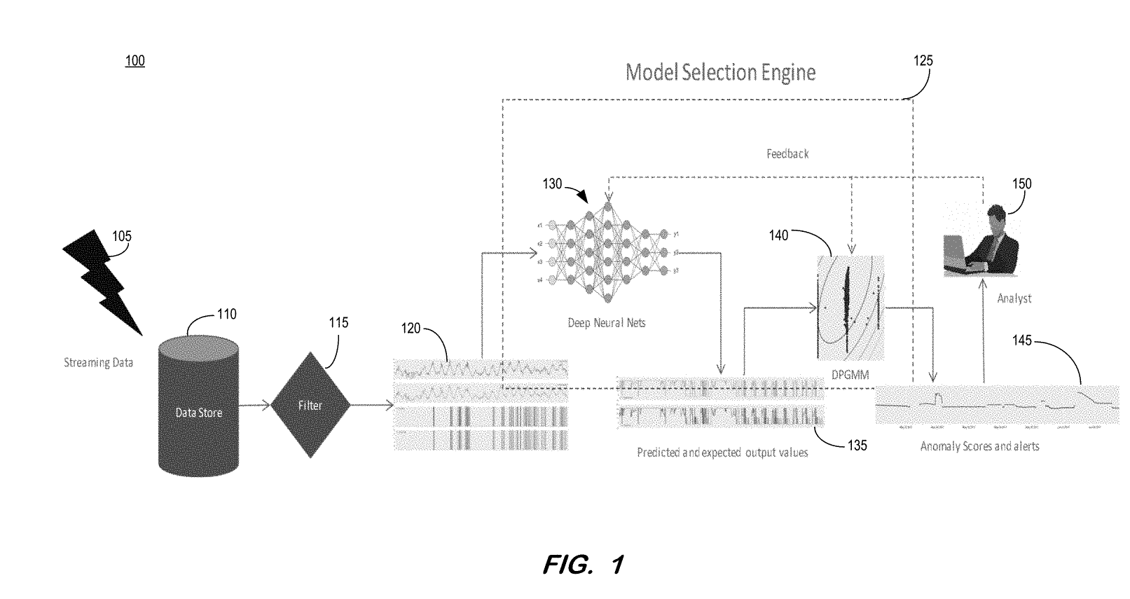

FIG. 1 is an illustrative example of a framework 100 for anomaly detection, according to some embodiments. Streaming data 105 is received by framework 100 and stored in data store 110. Data store 110 may include a database management system including one or more nodes. The streaming data may be real-time data from a HVAC (or other) system. The filter flags for filter 115 may be defined as disclosed herein. In an instance the conditions specified by the filter flags defined for a component of interest are satisfied, data from data store 115 is filtered to obtain filtered sensor values 120. The filtered sensor values 120 are then transmitted to a modeler 130.

In some embodiments, modeler 130, as part of model selection engine 125, may be implemented as a deep neural network. Other model types may be used however. The modeler may build a model based on the model inputs defined for the component for the HVAC (or other) system being modeled and output the predicted output values 135. The predicted output values are used by detector 140 to identify and determine if anomalies are indicated by the differences between the predicted output values and the actual observed output values from the component of interest. The results of the anomaly detection and anomaly scoring is output at 145, where the detected anomalies can be scored (i.e., ranked) and stored for further processing and/or reporting. A detection model may be determined based on the divergences to generate the anomaly score for the component of interest. In some embodiments, an anomaly score may be expressed as the inverse of the probability such that a low (high) probability of obtaining a particular value may correspond to a high (low) anomaly score.

In some embodiments, an analyst (or other personnel) 150 may monitor the operations of modeler 130 and detector 140 and provide feedback thereto based, at least in part, on the anomaly scores provided as an output of framework 100. In some embodiments, the modeling and anomaly detection disclosed herein may be executed automatically by model selection engine 125 and modeler 130. In some embodiments, the automatic anomaly detection of a system herein may include updating and/or revising of an acceptable range for a divergence between the predicted output values and the actual observed output values from a component of interest in a continuous self-learning manner to, for example, reduce potential false alarms and improve coverage.

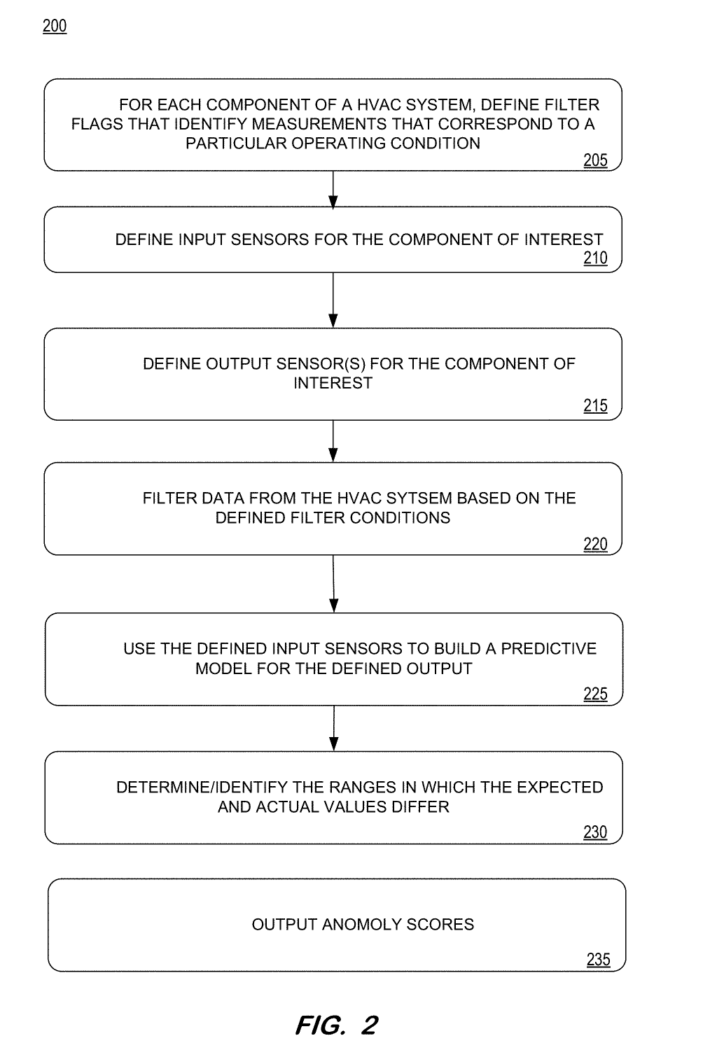

FIG. 2 is an example of a flow diagram of a process 200 herein. At operation 205, filter flags are defined for each component of the HVAC system. At operation 210, inputs sensors are defined for the component of interest and operation 215 includes defining output sensors for the component of interest.

At operation 220, data for the HVAC system is filtered based on the specified/defined filter conditions. If the defined operating conditions do not exist, then the process ends. Operation 225 includes using the defined input sensors to build a predictive model for the specified output.

In some embodiments, the predictive model uses a regression method, such as a neural network. However, other regression models/techniques to predict the defined output sensor value(s) may be used other than a neural network.

At operation 230, an anomaly detector may determine or identify ranges in which the expected and actually observed supply temperatures differ. If the difference is greater than a certain defined threshold, then an anomaly may be indicated. Anomalies may be scored or ranked and the anomaly score may be output (e.g., as a record, report, or visualization) at operation 235.

In some instances, the logic of process 200 may be applied to the heater and damper subsystems of the HVAC system of the present example. Additionally, the logic of process 200 may be applied to systems comprising subsystems or components other than an HVAC system. That is, the modeling scheme disclosed herein can derive expected output values from each of the components of a HVAC (or other) system to generate a component-specific score for each component (sub-)system comprising a system and an overall system score.

In some embodiments, a modeler herein learns to predict what the output should be. In some instances, the modeler might be implemented as a neural network. However, other types of regression models might be used to arrive at a predictor.

In some embodiments, a detector herein might include a Gaussian mixture model. However, any model that can arrive at a distribution or infer acceptable range(s) for certain values may be used in some embodiments herein.

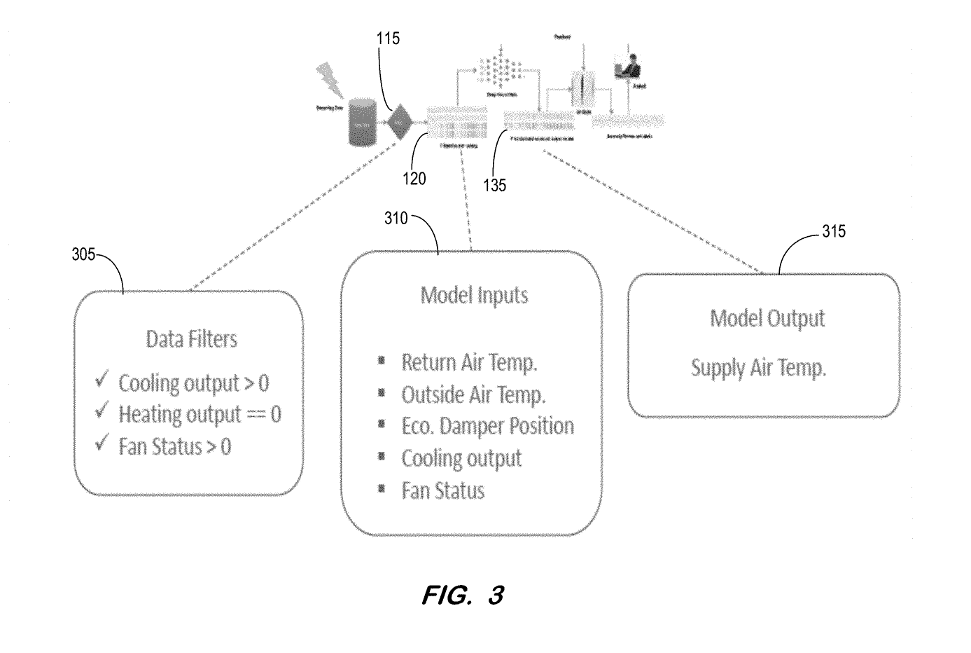

FIG. 3 is an illustrative example of an anomaly detection system (e.g., system 100 shown in FIG. 1) and the data types for a cooler model, in some embodiments. The filter 115 uses the data filters shown at 305 and the model inputs 310 are used as filtered sensor values for input to the modeler. The modeled cooler outputs the model output shown at 315 (i.e., supply air temperature).

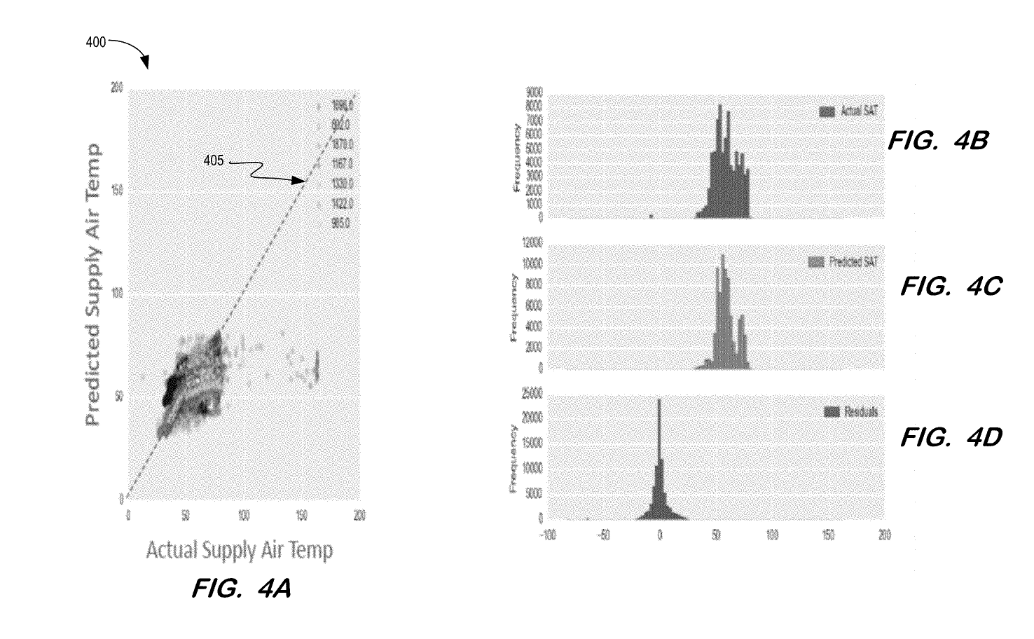

FIGS. 4A-4D include illustrative graphs charting data related to the actual supply air temperature (SAT) and predicted SAT for the cooler component of the present HVAC system example. FIG. 4A includes a graph 400 of the actual SAT and the predicted SAT. As illustrated by the diagonal line 405 that represents a matching correlation between the actual SAT and the predicted SAT, the actual SAT values correlate strongly with the predicted SAT values in FIG. 4A. FIG. 4B is a chart of the actual SAT values, FIG. 4C is a graph of the predicted SAT values, and FIG. 4D is a chart of the difference between the actual and predicted SAT values (i.e., the residuals). As illustrated by the residual values being centered about the value zero, there is a close correlation between the actual SAT values and the predicted SAT values in the range of about 45 to about 80. There are some actual data values that do not correlate to the predicted SAT values. These are shown in the charts as well. The values outside of the closely correlated values can be investigated to determine whether they are anomalies indicative of an unhealthy system.

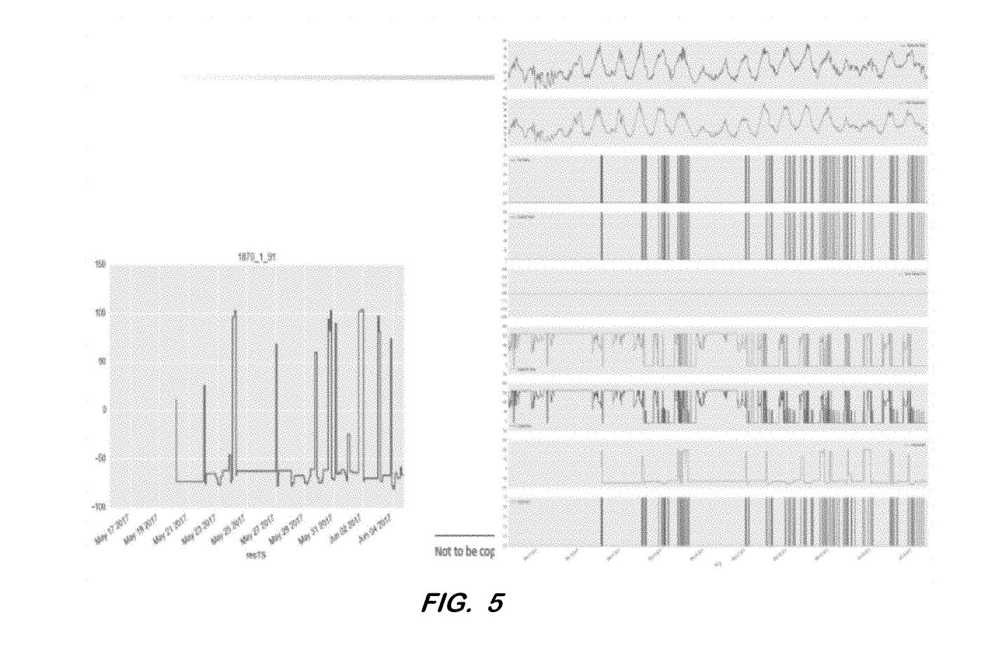

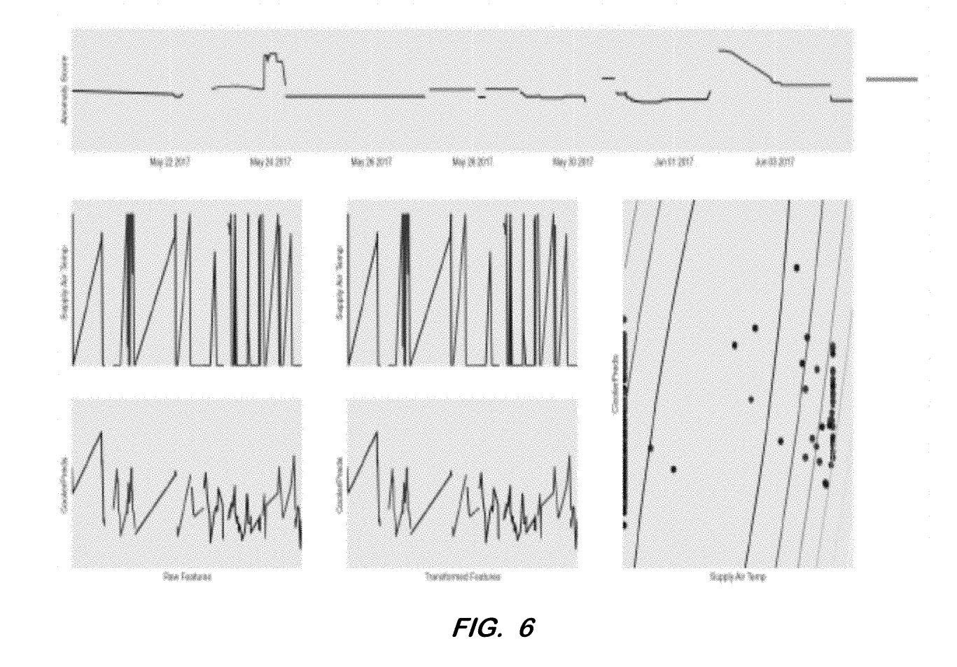

FIG. 5 includes charts or graphs of data illustrating data applied to a regressor for a cooler in an example herein, where the observed data values did not correlate with the predicted SAT values. As an example, FIG. 6 includes charts or graphs of data illustrating data applied to a detector for a cooler in an example herein, where the observed data values did not correlate with the predicted SAT values.

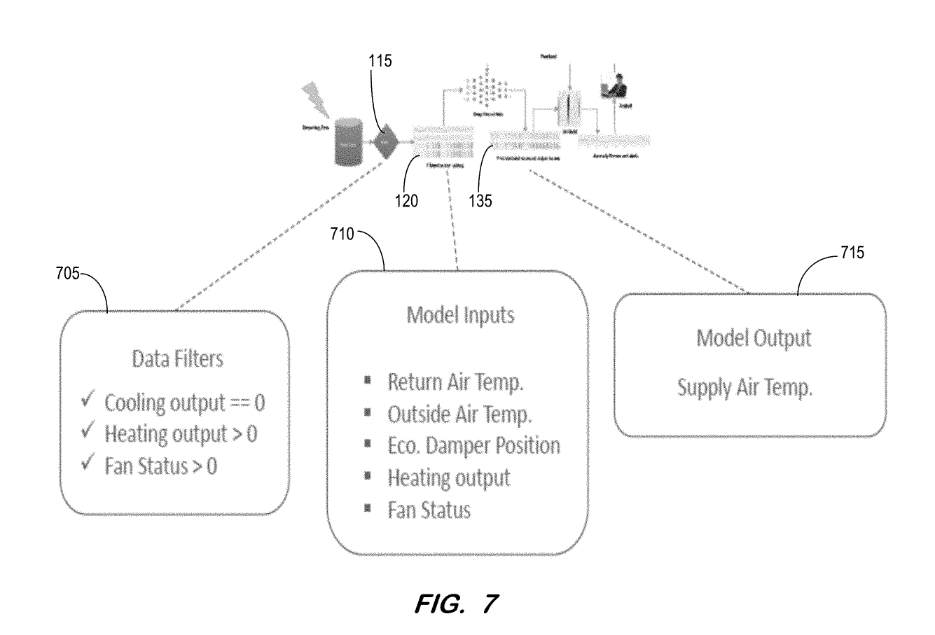

FIG. 7 is an illustrative example of an anomaly detection system (e.g., system 100 shown in FIG. 1) and the data types for a heater model, in some embodiments. The filter 115 uses the data filters shown at 705 and the model inputs 710 are used as filtered sensor values for input to the modeler. The modeled heater outputs the model output shown at 715 (i.e., supply air temperature).

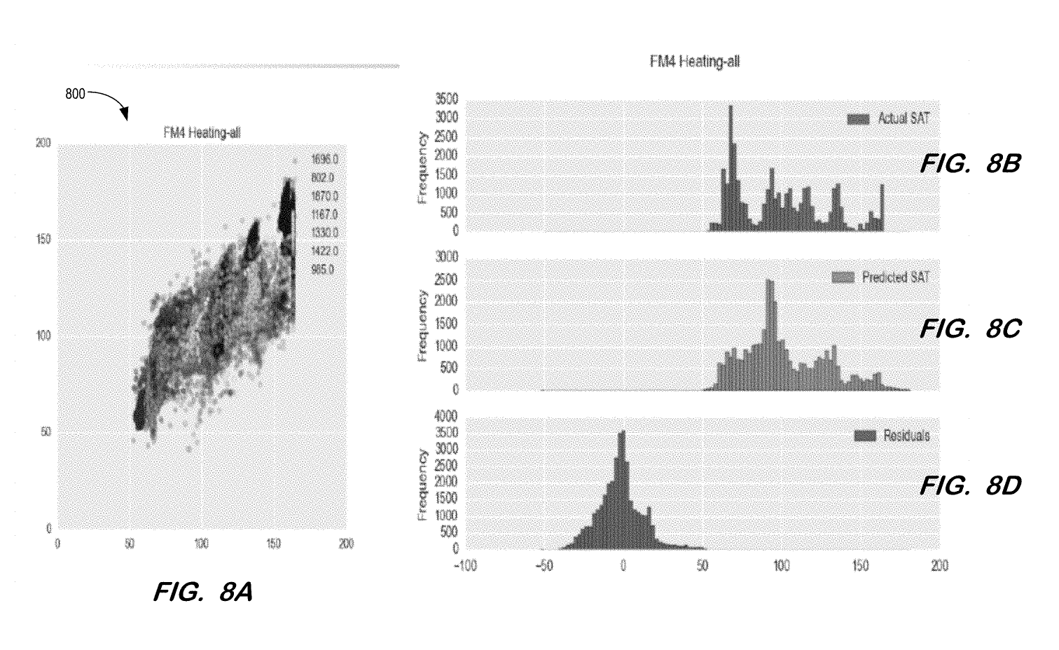

FIGS. 8A-8D include illustrative graphs charting data related to the actual supply air temperature (SAT) and predicted SAT for the heater component of the present HVAC system example. FIG. 8A includes a graph 800 of the actual SAT and the predicted SAT. The actual SAT values correlate strongly with the predicted SAT values in FIG. 8A. FIG. 8B is a chart of the actual SAT values, FIG. 8C is a graph of the predicted SAT values, and FIG. 8D is a chart of the difference between the actual and predicted SAT values (i.e., the residuals). As illustrated by the residual valued being centered about the value zero. There are some actual data values that do not correlate to the predicted SAT values. These are shown in the charts as well. The values outside of the closely correlated values can be investigated to determine whether they are anomalies indicative of an unhealthy system.

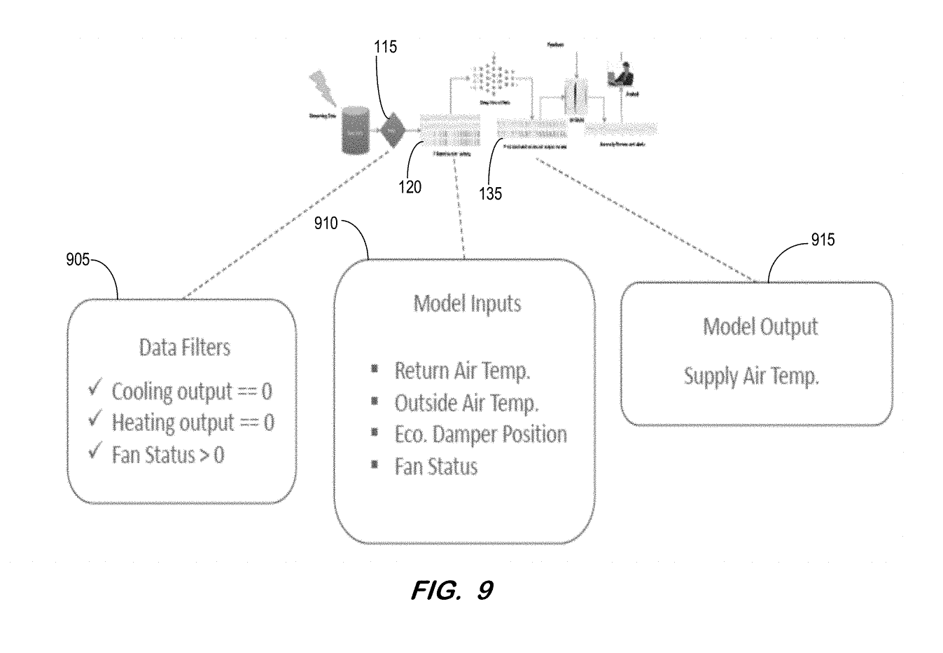

FIG. 9 is an illustrative example of an anomaly detection system (e.g., system 100 shown in FIG. 1) and the data types for a cooler model, in some embodiments. The filter 115 uses the data filters shown at 905 and the model inputs 910 are used as filtered sensor values for input to the modeler. The modeled heater outputs the model output shown at 915 (i.e., supply air temperature).

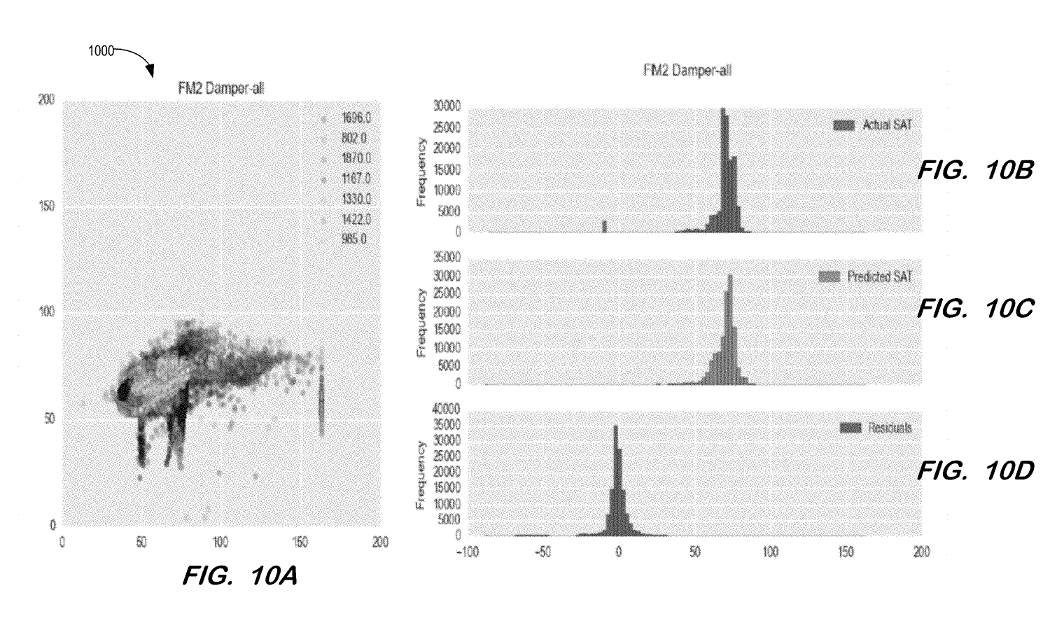

FIGS. 10A-10D include illustrative graphs charting data related to the actual supply air temperature (SAT) and predicted SAT for the cooler component of the present HVAC system example. FIG. 10A includes a graph 1000 of the actual SAT and the predicted SAT. The predicted SAT, the actual SAT values correlate strongly with the predicted SAT values in FIG. 10A. FIG. 10B is a chart of the actual SAT values, FIG. 10C is a graph of the predicted SAT values, and FIG. 10D is a chart of the difference between the actual and predicted SAT values (i.e., the residuals). As illustrated by the residual valued being centered about the value zero. There are some actual data values that do not correlate to the predicted SAT values. These are shown in the charts as well. The values outside of the closely correlated values can be investigated to determine whether they are anomalies indicative of an unhealthy system.

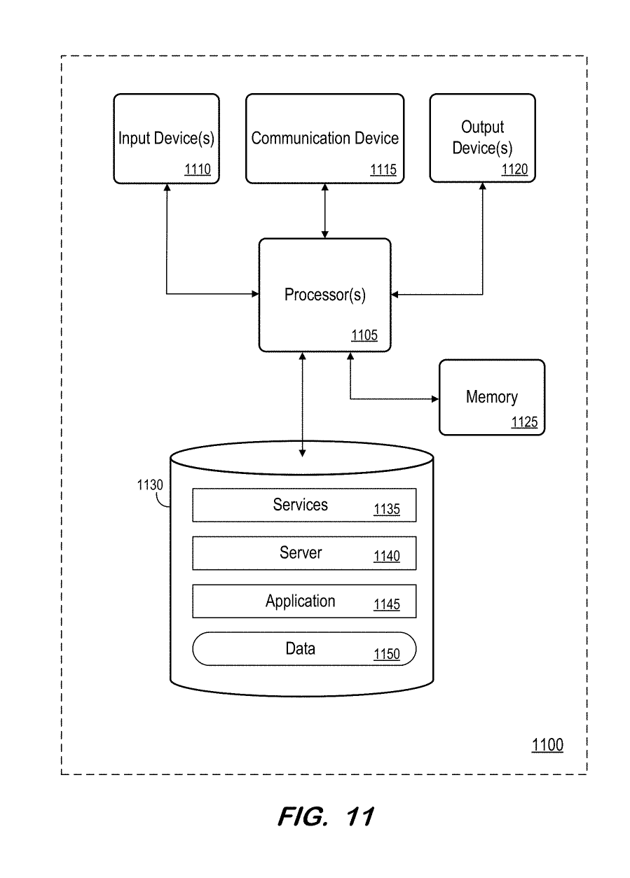

FIG. 11 is a block diagram of apparatus 1100 according to one example of some embodiments. Apparatus 1100 may comprise a computing apparatus and may execute program instructions to perform any of the functions described herein. Apparatus 1100 may comprise an implementation of a system (e.g., a server, DBMS and data store to implement the system of FIG. 1 in some embodiments). Apparatus 1100 may include other unshown elements according to some embodiments.

Apparatus 1100 includes processor 1105 operatively coupled to communication device 1115, data storage device 1130, one or more input devices 1110, one or more output devices 1120 and memory 1125. Communication device 1115 may facilitate communication with external devices, such as a reporting client, or a data storage device. Input device(s) 1110 may comprise, for example, a keyboard, a keypad, a mouse or other pointing device, a microphone, knob or a switch, an infra-red (IR) port, a docking station, and/or a touch screen. Input device(s) 1110 may be used, for example, to enter information into apparatus 1100. Output device(s) 1120 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), solid state storages device, optical storage devices, Read Only Memory (ROM) devices, Random Access Memory (RAM), Storage Class Memory (SCM) or any other fast-access memory.

Services 1135, server 1140, and application 1145 may comprise program instructions executed by processor 1105 to cause apparatus 1100 to perform any one or more of the processes described herein (e.g., process 200). Embodiments are not limited to execution of these processes by a single apparatus.

Data 1150 (either cached or a full database) may be stored in volatile memory such as memory 1125. Data storage device 1130 may also store data and other program code for providing additional functionality and/or which are necessary for operation of apparatus 1100, such as device drivers, operating system files, etc.

In some aspects, some of the systems and methods disclosed herein provide mechanisms to address the technical problem of how to manage systems to, for example, prevent unscheduled maintenance and/or outages, as well as improving energy efficiencies for the systems.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program instructions stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The embodiments described herein are solely for the purpose of illustration. Those in the art will recognize other embodiments which may be practiced with modifications and alterations.

What is claimed is:

1. A system comprising:
a processor; and
a memory in communication with the processor, the memory storing program instructions, the processor operative with the program instructions to perform the operations of:
defining, for each component of a system, filter flags that identify measurements that correspond to a particular operating condition of the respective component, the identified measurements being sensor measurements relevant to build a predictive model of expected output for each component of the system;
defining input sensors for each of the components of the system;
defining at least one output sensor for each of the components of the system;
filtering, for each of the components of the system, data from the system based on the defined filter flags for each respective component;
building, for each of the components of the system and based on the defined input sensors for each respective component, a predictive model for the defined output sensor;
determining, for each of the components of the system, a divergence between actual data values and expected values predicted by the model for each respective component;
determining a component-specific anomaly score for each component of the system based on the divergence determined for each respective component; and
storing a record of the component-specific anomaly score for each component of the system.

2. The system of claim 1, further comprising:
determining, in response to the filtering of the data from the system based on the defined filter flags for each respective component, whether the particular operating condition of the respective component is satisfied; and
in an instance the particular operating condition of the respective component is satisfied, then proceeding to build the model for the respective component, otherwise not proceeding to build the model for the respective component.

3. The system of claim 1, wherein the system comprises a heating, ventilation, and air conditioning (HVAC) system.

4. The system of claim 3, wherein the components of the HVAC system include at least a cooler, a heater, and a damper.

5. The system of claim 1, wherein the components of the system include devices whose proper operation, alone or in combination with each other, indicate a health of the system.

6. The system of claim 1, wherein the predictive model for a component of the system uses a regression methodology to predict the defined output for the respective component.

7. The system of claim 1, further comprising determining an acceptable range for the divergence between the actual data values and the expected values predicted by the model for each respective component.

8. The system of claim 7, wherein the acceptable range for the divergence between the actual data values and the expected values predicted by the model for each respective component is automatically revised based on a self-learning process and updated data from the system.

9. The system of claim 8, wherein the self-learning process is continuous.

10. The system of claim 1, further comprising:
determining an overall anomaly score for the system based on at least one of the component-specific anomaly scores for the system; and
storing a record of the overall anomaly score for the system.

11. A computer-implemented method comprising:
defining, for each component of a system, filter flags that identify measurements that correspond to a particular operating condition of the respective component, the identified measurements being sensor measurements relevant to build a predictive model of expected output for each component of the system;
defining input sensors for each of the components of the system;
defining at least one output sensor for each of the components of the system;
filtering, for each of the components of the system, data from the system based on the defined filter flags for each respective component;
building, for each of the components of the system and based on the defined input sensors for each respective component, a predictive model for the defined output sensor;
determining, for each of the components of the system, a divergence between actual data values and expected values predicted by the model for each respective component;
determining a component-specific anomaly score for each component of the system based on the divergence determined for each respective component; and
storing a record of the component-specific anomaly score for each component of the system.

12. The method of claim 11, further comprising:
determining, in response to the filtering of the data from the system based on the defined filter flags for each respective component, whether the particular operating condition of the respective component is satisfied; and
in an instance the particular operating condition of the respective component is satisfied, then proceeding to build the model for the respective component, otherwise not proceeding to build the model for the respective component.

13. The method of claim 11, wherein the system comprises a heating, ventilation, and air conditioning (HVAC) system.

14. The method of claim 13, wherein the components of the HVAC system include at least a cooler, a heater, and a damper.

15. The method of claim 11, wherein the components of the system include components whose proper operation, alone or in combination with each other, indicate a health of the system.

16. The method of claim 11, wherein the predictive model for a component of the system uses a regression methodology to predict the defined output sensor for the respective component.

17. The method of claim 11, further comprising determining an acceptable range for the divergence between the actual data values and the expected values predicted by the model for each respective component.

18. The method of claim 17, wherein the acceptable range for the divergence between the actual data values and the expected values predicted by the model for each respective component is automatically revised based on a self-learning process and updated data from the system.

19. The method of claim 18, wherein the self-learning process is continuous.

20. The method of claim 11, further comprising:
determining an overall anomaly score for the system based on at least one of the component-specific anomaly scores for the system; and
storing a record of the overall anomaly score for the system.
